(19) United States
(12) Patent Application Publication
(10) Pub. No.: US 2010/0083336 A1
(43) Pub. Date: Apr. 1, 2010

(54) METHOD AND APPARATUS FOR PROVIDING RICH MEDIA SERVICE

(75) Inventors: Seo Young HWANG, Suwon-si (KR); Jac Yeon Song, Seoul (KR); Gun Ill Lee, Seoul (KR); Kook Heui Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/569,316

(22) Filed: Sep. 29, 2009

(30) Foreign Application Priority Data
Sep. 29, 2008 (KR) 10-2008-0095230
Oct. 10, 2008 (KR) 10-2008-0099767
Jan. 22, 2009 (KR) 10-2009-0005590

(51) Int. Cl. H04N 7/173

(52) U.S. Cl. 725/131; 725/116

(57) ABSTRACT

A method and apparatus for providing rich media service that is capable of serving rich media contents in adaptation to terminal capability and condition using the information on the complexity of the content and the operation level and memory space required to render the content is provided. The rich media service provision method includes defining scene component elements composing a rich media content and attributes of the scene component elements; calculating operation amount required to render the rich media content; generating the rich media content composed of the scene component elements and attributes, the operation amount being contained one of the scene component elements and attributes; and encoding and transmitting the rich media content.

### PRIORITY

This application claims priority under 35 U.S.C. §119(e) to applications entitled “METHOD AND APPARATUS FOR PROVIDING RICH MEDIA SERVICE” filed in the Korean Intellectual Property Office on Sep. 29, 2008, Oct. 10, 2008 and Jan. 22, 2009, and assigned Serial Nos. 10-2008-0095230, 10-2008-0099767 and 10-2009-0005590, respectively, the contents of which are incorporated herein by reference.

### BACKGROUND OF THE INVENTION

1. Field of the Invention

The present invention relates to a media provision service and, in particular, to a method and apparatus for providing rich media service that is capable of providing rich media content.

2. Description of the Related Art

With the convergence of broadcast and communication media, there are needs to develop new types of services for customers in the broadcast and communication markets. Accordingly, recent broadcast and communication technologies are being developed for mobile terminals such as mobile phones and Personal Digital Assistants (PDAs) to process rich media services provided in the form of mixed content containing various types of contents such as text, audio, video, fonts, and graphics.

There are two well-know rich media service standards: Lightweight Application Scene Representation (LASeR) and Binary Format for Scene (BIFS).

A rich media service provides enriched contents with free representation of various multimedia elements and interaction with the user using such data as scene description, video, audio, image, font, text, metadata, and script.

Once a rich media service content is received, the mobile terminal decodes the received rich media service content. The mobile terminal performs a service configuration operation for providing the user with the decoded rich media content in an appropriate format. The mobile terminal checks and executes commands and processes events. In order to provide the user with the configured service, the mobile terminal outputs the multimedia data such as video and audio of the configured service through corresponding user interface means. As an exemplary service content, the LASeR content can be expressed by the syntax in Table 1.

TABLE 1

<NewScene>
<svg>
...
</svg>
</NewScene>

Referring to Table 1, the terminal configures and displays scenes (<svg> . . . </svg>) included in a corresponding LASeR command every time the LASeR command (<NewScene>) is executed.

According to recent technologies such as Digital Video Broadcasting-Convergence of Broadcasting and Mobile Service (DVB-CBMS) and Internet Protocol Television (IPTV), each terminal can receive the same service on the converged network. In an exemplary case of the broadcast service, a broadcast stream can be received by the terminals having different display sizes, capabilities, and characteristics. That is to say, various types of terminals including digital TV and mobile phone can receive the same broadcast stream. In this case, a video content or a graphical effect that can be played in the high definition digital TV supporting high speed data reception and having fast data processing capability is likely to be delayed in reception, broken down, or slowed down in playback on the mobile terminals as data reception environments vary and data processing capabilities are low compared to the digital TV.

According to the condition and service environment of the mobile terminal, different results can appear. For instance, although two terminals A and B have the same display size and data processing capabilities, if terminal A operates without other running programs while terminal B operates with several other programs running, a complex geometric figure can be displayed normally on terminal A but delayed during its display on terminal B.

As described above, the conventional rich media service method has a drawback in that the same rich media content can be presented in different qualities depending on the capabilities, characteristics, service environments, and conditions of the mobile terminal.

### SUMMARY OF THE INVENTION

In order to overcome the problems of the prior art, the present invention provides a method and apparatus for providing a rich media service that is capable of providing a rich media content adapted to a terminal's capabilities and conditions using the information on the complexity of the content and the operation levels and memory space required to render the content.

The present invention also provides a method and apparatus for providing a rich media service that enables a recipient terminal to process the rich media content adapted to the conditions such as data processing capabilities, device characteristics, service environments, and operating conditions.

Although the data processing capability, service environment, and operation status are static factors, there are also variable factors such as data processing speed. Also, the same kinds of terminals may show different service results according to the operating system and/or platform. From the viewpoint of service provider, it is difficult to provide the rich media service in consideration of all the possible types and conditions of the terminals and predict the service results in consideration of variable factors. Accordingly, the present invention provides a method and apparatus that is capable of providing optimal rich media service to terminals situated in various conditions with reference to the information including complexity of the rich media content, operation levels and memory space required for the terminal to process the rich media content.

In accordance with an embodiment of the present invention, a method for providing a rich media service includes defining scene component elements composing a rich media content and attributes of the scene component elements; calculating operation levels required to render the rich media content; generating the rich media content composed of the scene component elements and attributes, the operation levels being contained one of the scene component elements and attributes; and encoding and transmitting the rich media content.

In accordance with another embodiment of the present invention, a method for processing a rich media content composed of scene component elements and attributes of the scene component elements includes receiving and decoding the rich media content having an operation level required to render the rich media content; extracting the operation level by analyzing the scene component elements and attributes of the rich media content; and rendering the rich media content using the extracted operation level.

In accordance with another embodiment of the present invention, a transmitter for providing a rich media service includes a scene component element definer which defines scene component elements composing a rich media content and arranges the scene component element to be placed at predetermined positions; an attribute definer which defines attributes of the scene component elements; an operation level calculator which calculates an operation level required to render the rich media content and inserts the operation level in at least one of the scene component elements and attributes; an encoder which encodes the rich media content composed of the scene component elements and attributes; and content transmitter which transmits the encoded rich media content.

In accordance with another embodiment of the present invention, a receiver for rendering a rich media content composed of scene component elements and attributes of the scene component elements includes a decoder which decodes a rich media content having an operation level required to render the rich media content; a scene tree manager which analyzes scene information of the rich media content and composes the rich media content according to the analysis result; and a renderer which renders and outputs the composed rich media content.

### BRIEF DESCRIPTION OF THE DRAWINGS

The above and other objects, features and advantages of the present invention will be more apparent from the following detailed description in conjunction with the accompanying drawings, in which:

FIG. 1 is a flowchart illustrating a rich media content processing method of a terminal according to an embodiment of the present invention;

FIG. 2 is a flowchart illustrating the operation amount and memory space analysis process of FIG. 1;

FIG. 3 is a flowchart illustrating a method for a transmitter to generate and transmit a LASeR content according to an embodiment of the present invention;

FIG. 4 is a block diagram illustrating a configuration of a transmitter for generating and transmitting a LASeR content according to an embodiment of the present invention; and

FIG. 5 is a block diagram illustrating a configuration of a receiver for receiving and processing a LASeR content transmitted by a transmitter according to an embodiment of the present invention.

### DETAILED DESCRIPTION OF EXEMPLARY EMBODIMENTS

Embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention. The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

In the following description, the rich media content is transmitted with the information such as content complexity and required operation levels and memory space such that the terminal received the rich media content can provide capability and service environment adaptive rich media service.

Although the rich media service provision method and apparatus is directed to the terminal based on a LASeR engine in the following description, the rich media service provision method and apparatus can be applied to terminals implemented with other types of Rich Media Engines (RMEs) in other embodiments. Although the rich media service provision method and apparatus is described with in terms and elements specified in the LASeR standard, it is obvious to those skilled in the art that the terms and elements constituting the engine, system, and data can be changed when another RME or system other than LASeR is adopted.

In the first embodiment of the present invention, the transmitter creates and transmits element and attribute information including the operation levels required for the terminal to configure Scene Component Elements of the rich media content, and the recipient terminal composes a scene using the element and attribute information in consideration of the terminal's capabilities and conditions. Here, the element is a basic unit of object constituting the scene, and the attribute means the property of an element.

In the second embodiment of the present invention, the transmitter creates and transmits element and attribute information including complexity required for configuring the rich media content, and the recipient terminal renders a scene using the element and attribute information of the rich media content in consideration of the terminal's capability and condition. Here, the element is a basic unit of object constituting the scene, and the attribute means the property of an element.

Also, the element and attribute information can contain the terminal operation levels required for configuring the scene component elements of the rich media content and complexity for rendering the rich media content such that the terminal renders a scene using the element and attribute information in consideration of the terminal's capability and condition.

Although the rich media service is described in association with LASeR content as the rich media content in the following descriptions, the present invention can be applied to various rich media services using other types of rich media contents.

### First Embodiment

In the first embodiment of the present invention, new elements and attributes related to the operation levels required for the terminal to configure the scene component elements rendering a LASeR content are defined, and a method for rendering the scene of the LASeR content using the attributes depending on the terminal capability and condition is described.

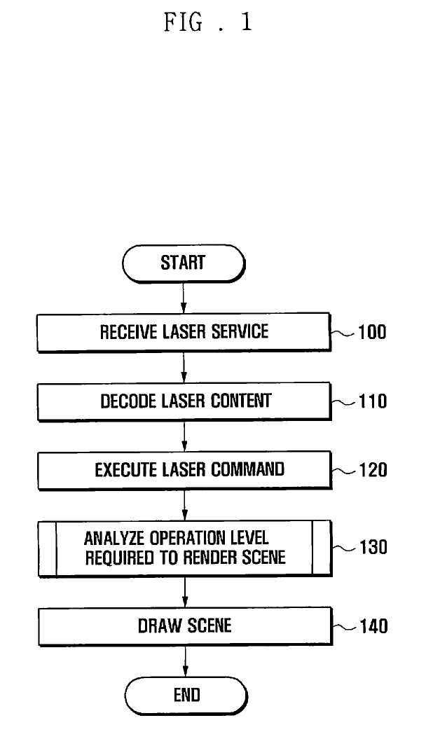

The transmitter generates the elements and attributes related to the operation levels required for the terminal to configure the scene component elements composing the LASeR content and transmits the information of the elements and attributes to the terminal together with the LASeR content. The terminal plays the LASeR content according to the procedure illustrated in FIG. 1.

FIG. 1 is a flowchart illustrating a rich media content processing method of a terminal according to an embodiment of the present invention.

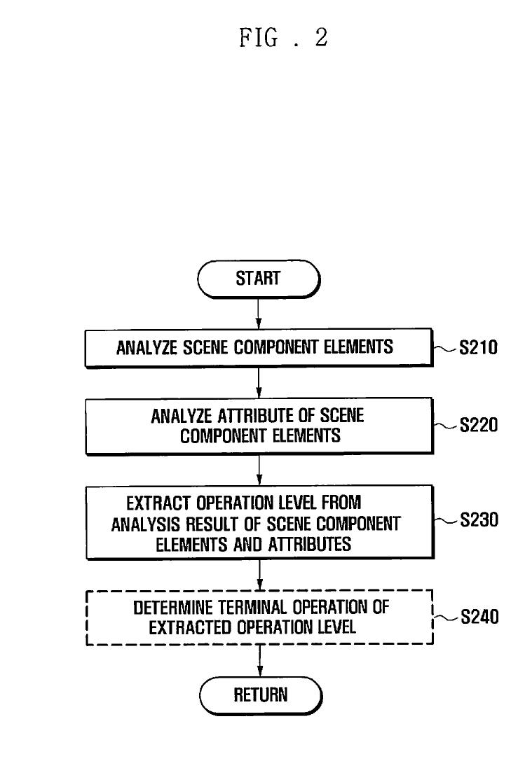

Referring to FIG. 1, the terminal first receives the LASeR service in step 100 and decodes the LASeR content of the LASeR service in step 110. Next, the terminal checks the LASeR commands contained in the decoded LASeR content and executes the LASeR commands in step 120. At this time, the terminal interprets the LASeR scene component elements included in the LASeR commands. The LASeR command specify changes to the scene in declarative way. For instance, ‘NewScene’ command creates a new scene, ‘Insert’ command inserts any element or attribute, and ‘Delete’ command deletes an element or attribute. The Scene component element of LASeR includes elements specifying the media and graphic objects composing a scene in declarative way, attributes, events, and script. In the first embodiment of the present invention, the LASeR content also includes the information related to the operation level and memory space required for the terminal to configure the scene component elements composing the LASeR content. Accordingly, the terminal analyzes the information related to the operation level and memory space required for the terminal to configure the scene component elements in step 130. How the terminal analyzes the operation amount and memory space information is described in more detail with reference to FIG. 2.

FIG. 2 is a flowchart illustrating the operation level and memory space analysis process of FIG. 1.

Referring to FIG. 2, the terminal interprets the LASeR scene component elements in step 210. Next, the terminal interprets the attributes of the LASeR scene component elements in step 220.

The interpreted scene component elements and/or attributes can include the operation level and memory space required for the terminal to configure the scene component elements. After interpreting the elements and attributes, the terminal extracts information about the operation level and memory space in step 230. Next, the terminal determines operations to be executed on the basis of the operation level and memory space information in consideration of its capability and condition in step 240. It is noted that step 240 is optional.

After extracting the operation level and memory space or determining operations to be executed base on the operation level and memory space, the terminal renders and displays the scene component elements of the LASeR content in accordance with its capability and condition. Table 2 shows an example of a LASeR content specified with newly defined attributes indicating the operation level required for the terminal to configure the LASeR scene described at step 130 of FIG. 1.

TABLE 2

```
...
    <g multiply=“5” div=“3” sub=“4” add=“7”
    ...
    </g>
...
```

Referring to Table 2, the ‘g’ element, as one of the scene component elements included in the LASeR content, can include at least one of ‘multiply’, ‘div’, ‘sub’, and ‘add’ attributes. As well as the ‘multiply’, ‘div’, ‘sub’, and ‘add’ attributes, operation related properties can be used as operation attributes. In Table 2, the ‘g’ element is a container element for grouping together various related elements. Accordingly, various scene component elements composing a rich media content can be nested in the ‘g’ element. Here, the component elements include graphics elements such as ‘rect’ element for drawing a rectangle and ‘circle’ element for drawing a circle and scene component elements of audio, video, and image. In the example of Table 2, the ‘g’ element specifies the operation level required for the terminal to draw all the scene component elements with 5 multiplication operations, 3 division operations, 4 subtraction operations, and 7 addition operations.

Table 3 shows exemplary definitions related to the new attributes used in Table 2. In an embodiment of the present invention, a scheme is used for defining the elements and attributes. The scheme is a document that describes valid formats of data. In an embodiment of the present invention, the scheme follows the ‘XML Schema’ syntax, and the scheme can be defined using elements of the scheme. The structures of the elements and attributes can be defined in various manners and thus other methods for defining the elements and attributes rather than using the scheme, if having the identical meaning, is envisioned by the present invention. Also, values of the elements and attributes defined in the present invention can be specified to be constrained to a unique presentation method or defined by extending the conventional type. Although set to ‘integer’ in the example of Table 3, the ‘type’ attribute can have various data types available in the rich media content such as integer, text string, fixed decimal, floating decimal, and list types including ‘string’, ‘boolean’, ‘decimal’, ‘precisionDecimal’, ‘float’, ‘double’, ‘duration’, ‘dateTime’, ‘time’, ‘date’, ‘gYearMonth’, ‘gYear’, ‘gMonthDay’, ‘gDay’, ‘gMonth’, ‘hexBinary’, ‘base64Binary’, ‘anyURI’, ‘QName’, ‘NOTATION’, ‘normalizedString’, ‘token’, ‘language’, ‘NMTOKEN’, ‘NMTOKENS’, ‘Name’, ‘NCName’, ‘ID’, ‘IDREF’, ‘IDREFS’, ‘ENTITY’, ‘ENTITIES’, ‘integer’, ‘nonPositiveInteger’, ‘negativeInteger’, ‘long’, ‘int’, ‘short’, ‘byte’, ‘nonNegativeInteger’, ‘unsignedLong’, ‘unsignedInt’, ‘unsignedShort’, ‘unsignedByte’, ‘positiveInteger’, ‘yearMonthDuration’, ‘enumeration’, to name a few. This is applied through the embodiments of the present invention.

TABLE 3

<attribute name=“multiply” type=“integer” use=“optional”/>
<attribute name=“div” type=“integer” use=“optional”/>
<attribute name=“sub” type=“integer” use=“optional”/>
<attribute name=“add” type=“integer” use=“optional”/>

The attributes defined in Table 3 can be used as the attributes of the container elements such as ‘svg’ and ‘g’ containing other elements as described with Table 2 as well as the attributes of all the elements composing a scene of the LASeR content. Also, these attributes can be used as the attributes of the LASeR header (LASeRHeader). The newly introduced attributes related to the operation level, the terminal capability and condition, and service environment that influence to the composition of the content can be defined into groups designated for the identical properties or roles.

Tables 4 and 5 show exemplary LASeR content generated with the new elements and attributes representing information related to the operation amount required for the terminal to render LASeR scene described at step 130 of FIG. 1.

TABLE 4

<operation multiply=“5” div=“3” sub=“4” add=“7”>
<g>
...
</g>
</operation>
...

As shown in Table 4, the new ‘operation’ element such as ‘multiply’, ‘div’, ‘add’, and ‘sub’ related to operation can contain the ‘g’ element as a scene component element composing the LASeR content. In Table 4, the ‘operation’ element specifies the operation level required for the terminal to draw all the scene component elements contained in the ‘g’ element with 5 multiplication operations, 3 division operations, 4 subtraction operations, and 7 addition operations.

```
TABLE 5
...
  <operation id=“ope_01”multiply=“5” div=“3” sub=“4” add=“7”/>
  <operation id=“ope_02”multiply=“1” div=“1” sub=“3” add=“2”/>
  <operation id=“ope_03”multiply=“2” div=“2” sub=“4” add=“5”/>
  <g id=“group_01” ope_ref“ope_01” transform=“translate(100,100)”>
  ...
  </g>
  <g id=“group_02”>
  ...
    <rectid=“ractangle” ope_ref=“ope_02” .../>
  ...
  </g>
  <animationMotion id=“ani_01” ope_ref=“ope_03” .../>
```

Referring to Table 5, the ‘operation’ elements containing the newly introduced ‘multiply’, ‘div’, ‘sub’ and ‘add’ elements are referenced by the scene component elements such as ‘g’, ‘rect’, and ‘animationMotion’ composing the LASeR content.

In Table 5, the operation level required for the terminal to draw all the scene component elements contained in the ‘g’ element of which ‘id’ attribute is set to ‘group_{—}01’ is determined with 5 multiplication operations, 3 division operations, 4 subtraction operations, and 7 addition operations by referencing the ‘operation’ element of which ‘id’ attribute is set to ‘ope_{—}01’; the operation level required for the terminal to draw the ‘rect’ element of which ‘id’ attribute is set to ‘rectangle’ is determined with 1 multiplication operation, 1 division operation, 3 subtraction operations, and 2 addition operations by referencing the ‘operation’ element of which ‘id’ attribute is set to ‘op_{—}02’; and the operation level required for the terminal to draw the ‘animationMotion’ element of which ‘id attribute is set to ‘ani_{—}01’ is determined with 2 multiplication operations, 2 division operations, 4 subtraction operations, and 5 addition operations by referencing the ‘operation’ element of which ‘id’ attribute is set to ‘op_{—}03’.

Table 6 shows a scheme defining the new elements and attributes used in Tables 4 and 5.

TABLE 6

```
<attributeGroup name=“operationAttributeGroup”>
  <attribute name=“multiply” type=“integer” use=“operationa”/>
  <attribute name=“div” type=“integer” use=“operationa”/>
  <attribute name=“sub” type=“integer” use=“operationa”/>
  <attribute name=“add” type=“integer” use=“operationa”/>
</attributeGroup>
<complextype=“operationType”>
  <attributeGroup ref=“operationAttributeGroup”/>
  <attributeGroup ref=““lsr:basic”/>
  <attributeGroup ref=“lsr:href”/>
</complexType>
<elementname=“operation” type=“operationType”/>
```

The new attributes related to the operation amount can be defined separately as shown in Table 3 or to be designated into a group such as ‘operationAttributeGroup’ for the new attributes related to the operation amount as shown in Table 6.

Table 7 shows new attributes related to the memory space required for the terminal to render the LASeR scene described at step 130 of FIG. 1.

TABLE 7

<attribute name=“GraphicPoints” ... />
<attribute name=“FontDataSize” ... />
<attribute name=“TextDataSize” ... />
<attribute name=“ImageProcessingMemory” ... />
<attribute name=“VideoProcessingMemory” ... />

In Table 7, the attribute ‘GraphicPoints’ gives information on the memory space required for rendering a graphics element. This attribute can include the information on the point, line, mesh, and polygon constituting graphics elements and can be used as an attribute for giving information required according to the properties of the graphics element. For instance, if the information for presenting the memory space required for rendering a graphic object A is a point, the ‘GraphicPoints’ attribute can be set to a number of points required for composing the graphic object A. This attribute can include further information such as a size of the point and memory allocation amounts, etc. In the case where the information for expressing the memory space required for a graphic object B is a mesh and polygon, the ‘GraphicPoints’ attribute can include further information such as numbers, amounts, sizes of meshes and polygons.

The attribute ‘FontDataSize’ gives information on the memory space required for rendering data with the corresponding font. The ‘FontData’ attribute can be configured to give information on the size of the font file. When there is further information to render the data using the font file, e.g. information required for loading the font file, supplementary attributes for giving the corresponding information can be defined, or the ‘FontDataSize’ attribute can be set to a value reflecting such information.

The attribute ‘TextDataSize’ gives information on the memory space required for rendering text data. This attribute can be configured to show the information such as the size of the text data. When there is further information requiring memory for rendering the text data, supplementary attributes for giving the corresponding information can be defined, or the ‘TextDataSize’ abbribute can be set to a value reflecting such information.

The attribute ‘ImageProcessingMemory’ gives information on the memory space required for rendering image data. When there is further information requiring memory for rendering the image data, supplementary attributes for expressing the corresponding information can be defined, or the ‘ImageProcessingMemory’ attribute can be set to a value reflecting the corresponding information. For instance, if there are further factors for processing the image file, such as input video buffer, decoding parameters, and output video buffer, further memory spaces can be required for the input video buffer size greater than the image file size and the output video buffer size corresponding to the sum of a multiplication of the horizontal and vertical lengths and a number of bytes for expressing the data per pixel and variables for decoding the image. Accordingly, the ‘ImageProcessingMemory’ attribute includes the information on the image file size; the information on horizontal and vertical lengths and color format of the image and codec for determining the output video buffer size; and the information on the memory size required for the variables used in decoding the image. Such information can be expressed within the ‘ImageProcessingMemory’ attribute or by defining individual attributes. The information on the input video buffer size and decoding variables may require different sizes of memory depending on the transmission method and/or implementation method, and the information which is a variable significantly varying the required memory space can be excluded when expressing the memory space required for the ImageProcessingMemory’ or expressed with a specific value.

The attribute ‘VideoProcessingMemory’ gives information on the memory space required for rendering video data. When there is further information requiring memory for rendering the video data, supplementary attributes for expressing the corresponding information can be defined, or the ‘VideoProcessingMemory’ attribute can be set to a value reflecting the corresponding information. For instance, if there are further factors for processing the video file, such as input video buffer, decoding parameters, output video buffer, and decoded picture buffer, further memory space can be required for the input video buffer size greater than the image file size, the output video buffer size corresponding to the sum of a multiplication of the horizontal and vertical lengths and a number of bytes for expressing the data per pixel, decoded video buffer, and variables for decoding the video data. Accordingly, the ‘VideoProcessingMemory’ attribute includes the information on the image file size; the information on horizontal and vertical lengths and color format of the image and codec for determining the output video buffer size; and the information on the memory size required for the variables used in decoding the image. Such information can be expressed within the ‘VideoProcessingMemory’ attribute or by defining individual attributes. The information on the input video buffer size and decoding variables may require different sizes of memory depending on the transmission method and/or implementation method, and the information which is a variable significantly varying the required memory space can be excluded when expressing the memory space required for the ‘VideoProcessingMemory’ or expressed with a specific value.

The new attributes for expressing information related to the memory required for the terminal to render the LASeR scene can be used for the attributes of all kinds of the elements composing the scene of the LASeR content and can be used with conditions or restrictions according to the characteristics of the element. Also, the new attributes can be defined into groups designated for identical properties or roles. Also, the new attributes related to the memory that are described with reference to Tables 4 and 5 can be contained in a new element ‘min_Memory’ and used as follows: <min_Memory GraphicPoints=“ . . . ” FontDataSize=“ . . . ” TextDataSize=“ . . . ” ImageProcessingMemory=“ . . . ” VideoProcessingMemory=“ . . . ”>. Also, a new attribute including the information of the new attributes related to the memory can be defined as <attribute name=“min_Memory”>. For instance, if min_Memory=10, this means that the least memory amount required for the terminal to render the scene using the element having the corresponding attribute is 10 memory size units. This can be expressed as an attribute value of a list type by listing the individual attribute values related to the memory as min_Memory=“2^{GraphicPoints}2^{FontDataSize}2^{TextDataSize}2^{ImageProcessingMemory}2^{VideoProcessingMemory}2^{AudioProcessingMemory}”. In this case, the values of GraphicPoints, FontDataSize, TextDataSize, ImageProcessingMemory, VideoProcessingMemory, and AudioProcessingMemory attributes are expressed as the values of the required memory of the respective objects converted to be represented by squares of 2, respectively. The list of the values can further include various parameters for providing information related to the memory. The unit of memory can be changed according to the system and expressed with all possible memory presentation units such as a byte, a bit, a MegaByte (MB), a KiloByte (KB), etc. Also, the least memory required for rendering the scene using the element having the corresponding attribute can be classified into levels or groups so as to be expressed with a symbolic value, group, or level (e.g. High, Medium, and Low).

As aforementioned, the structures of the elements and attributes can be defined in various manners and thus other methods for defining the elements and attributes rather than using the scheme, if having identical meaning, is envisioned by the present invention. Also, the values of the elements and attributes defined in the present invention can be specified to be restricted to a unique presentation method or defined by extending the conventional type. The types of the newly defined attributes can be designated with various data types such as ‘string’, ‘boolean’, ‘decimal’, ‘precisionDecimal’, ‘float’, ‘double’, ‘duration’, ‘dateTime’, ‘time’, ‘date’, ‘gYearMonth’, ‘gYear’, ‘gMonthDay’, ‘gDay’, ‘gMonth’, ‘hexBinary’, ‘base64Binary’, ‘anyURI’, ‘QName’, ‘NOTATION’, ‘normalizedString’, ‘token’, ‘language’, ‘NMTOKEN’, ‘NMTOKENS’, ‘Name’, ‘NCName’, ‘ID’, ‘IDREF’, ‘IDREFS’, ‘ENTITY’, ‘ENTITIES’, ‘integer’, ‘nonPositiveInteger’, ‘negativeInteger’, ‘long’, ‘int’, ‘short’, ‘byte’, ‘nonNegativeInteger’, ‘unsignedLong’, ‘unsignedInt’, ‘unsignedShort’, ‘unsignedByte’, ‘positiveInteger’, ‘yearMonthDuration’, and enumeration.

Although the operation level and memory space required for the terminal to render the scene of a rich media service is used as an exemplary element that influences when composing the content in association with the terminal capacity and condition and service environment, it is obvious that other elements that influence when composing the content in association with the terminal capacity and condition and service environment are envisioned by the present invention.

As exemplary elements that influence the composition of the content in association with the terminal capacity and condition and service environment, the information related to the media such as image, font, video, and audio, and information related to text, graphics, and interaction, and other various elements that are not enumerated herein. The information related to the media such as image, font, video and audio, the information related to the interaction can include information about the data itself such as data size, playback time, data amount per second such as frame rate, color table, update rate, and the numbers of elements and attributes. Also, the resolution required for the user to process the data, display size, utilization frequency in the service scene, occupancy rate of the terminal resource required for processing the data, memory size, power consumption, information on the resource required for data transmission, and input/output capability and structure of the terminal required for providing the service can be further included.

Also, the method for defining the information can vary according to the positions of the newly introduced elements and attributes. The elements and attributes information that are newly defined according to the respective data definition formats can be composed of the initial scene composition information such as header information and the signaling information for scene update, scene update data group, scene segment, and access unit; or composed of access units or header information regardless of the actual scene information for rendering the scene related to the signaling. In case of being structured in a data format for signaling, the newly defined elements and attributes can be composed of fields for indicating the corresponding information.

Besides the operation level, the information on the various elements constituting the content, i.e. the information on the media such as image, font, video, and audio, and the information related to the text, graphics, and interaction that constitute the content can be used for specifying a scene composition element or for specifying the grouped element, data set, or file.

### Second Embodiment

In the second embodiment of the present invention, new elements and attributes related to the complexity for the terminal to render a LASeR content are defined, and a procedure in which the terminal renders a scene of the LASeR content using the attributes depending on the terminal capability and condition is described. The term “element” means a basic unit of objects composing a scene, and the term “attribute” means a property of an element of the scene.

The procedure for rendering a LASeR content comprising elements and attributes having information on the complexity for the terminal to render the LASeR content is identical with that of the first embodiment of the present invention except that the terminal checks the complexity required to render the LASeR content at step 130 of FIG. 1. The terminal checks the complexity required for rendering the LASeR content depending on the terminal capability and condition and renders a scene of the service using the complexity information.

The complexity to render the LASeR content can include the operation level required for the terminal to configure the scene component elements described in the first embodiment of the present invention. A scene can be rendered in adaptation to the information such as the data processing performance among the terminal capability and characteristics, service environment and conditions. Here, the data processing performance is in proportion to the clock (in Mega Hertz (MHz)). When the maximum data processing performance of the terminal that is referenced to render the service is 2000 clocks as a reference data processing unit, the number of clocks is 5 for a multiplication operation or a division operation and 1 for an addition operation or a subtraction operation is 1. Since, there is various reference units for expressing the data processing performance, the data processing performance can be expressed with the unit used in the system. In a LASeR content case, the total operation level required to draw a human running as a scene component element includes 20 multiplications, 10 divisions, 25 additions, and 12 subtractions. Accordingly, the total number of clocks is 187 clocks by summing 5 clocks×20 multiplications=100 clocks, 5 clocks×10 divisions=50 clocks, 1 clock×25 additions=25 clocks, and 1 clock×12 subtractions. As a consequence, the data processing rate, i.e. the total number of clocks for drawing the human running to the 2000 clocks of the reference data processing unit, becomes 187/2000. The data processing rate of 187/2000 can be expressed in percentage, i.e. 9.35%, and thus 9.35% of the processing headroom is required for the terminal to draw the human running. This processing headroom required for rendering a scene is referred to as “complexity” in the second embodiment of the present invention. That is to say, the complexity can be defined as a percentage of the operation amount required for rendering a content to the maximum data processing performance of the terminal. In this case, the complexity of the human running becomes 9.35 on the scale of 1 to 100.

Although the complexity calculation is explained with the information related to the operation amount for the terminal to render the content, other various elements related to the memory, terminal capacity, service environment, and the like can be used for the complexity calculation. The elements for use in the complexity calculation can include properties related to the operations in addition to the aforementioned operation level. Also, the information related to the media such as image, font, video and audio, the information related to the text, graphics, and interaction, and information on the elements composing the content can be further used. The information related to the media such as image, font, video, and audio, and the information related to the text, graphics, and interaction can include the information of the data itself such as size, playback time, and data amount to be processed per second such as frame rate, color table, and update rate. Also, the resolution required for the user to process the data, display size, utilization frequency in the service scene, occupancy rate of the terminal resource required for processing the data, memory size, power consumption, information on the resource required for data transmission, and input/output capability and structure of the terminal required for providing the service can be further included.

Table 8 shows an exemplary LASeR content generated with a new attribute of complexity required to render the LASeR content.

TABLE 8

...
<g complexity=“9.35”>
<!-- elements for rendering a human running -->
</g>
...

In an example of Table 8, the ‘g’ element as one of the scene component elements composing the LASeR content has the ‘complexity’ attribute. The ‘g’ element, which is a container element for grouping together related elements, contains elements for drawing the human running. The ‘complexity’ attribute has a value of 9.35 and this means that the terminal is required to have available performance headroom of at least 9.35 compared to the maximum processing performance of 100 to render the human running. The ‘complexity’ attribute can be used for all the scene component elements including container elements. Also, the ‘complexity’ attribute can be used as an attribute of the LAseRHeader.

Tables 9 to 13 shows new attributes defined in syntax of the scheme of Table 7. The ‘complexity’ attribute is defined with a data type as shown in Tables 9 and 13.

TABLE 9

<attribute name=“complexity” type=“float” use=“optional”/>

As shown in Table 9, the ‘complexity’ attribute can be defined to be expressed in various data type such as ‘float’, ‘integer’, and ‘anyURI’ available in the corresponding rich media without any restrictions or conditions as described in the first embodiment.

```
TABLE 10
<attribute name=“complexity” type=“ZeroToOnefloat” use=“optional”/>
<simpleType name=“ZeroToOneFloat”>
    <restriction base=“float”>
        <minInclusive value=“0”/>
        <maxInclusive value=“100”/>
    </restriction>
</simpleType>
```

In Table 10, the ‘complexity’ attribute is defined with the data type of ‘float’ and restrictions of the minimum value of 0 and the maximum value of 100.

```
TABLE 11
<attribue name=“complexity” type=“ZeroToOnefloat” use=“optional”/>
<simpleType name=“ZeroToOneTenint”>
    <restriction base=“integer”>
        <minInclusive value=“0”/>
        <maxInclusive value=“10”/>
    </restriction>
</simpleType>
```

In the example of Table 11, the ‘complexity’ attribute is defined with the data type of ‘integer’ such that the value of the ‘complexity’ attribute is expressed after the normalization process. In the case where the normalization is adopted, the ‘complexity’ is expressed as an integer value in the range of 1 to 10, i.e. the values below 10% compared to maximum processing performance of 100 is normalized to 1, the values below 20% to 2, and so on.

```
TABLE 12
<attribue name=“complexity” type=“complexityType” use=“optional”/>
<simpleType name=“complexityType”>
    <restriction base=“string”>
        <enumeration value=“high”/>
        <enumeration value=“middele”/>
        <enumeration value=“low”/>
    </restriction>
</simpleType>
```

In Table 12, the ‘complexity’ attribute is defined with the data type of string such that the value is indicated by a text having a symbolic meaning. In this case, the value of the ‘complexity’ attribute can be set to ‘high’ indicating the high complexity or ‘low’ indicating the low complexity.

```
TABLE 13
<attribue name=“complexity” type=“complexityType” use=“optional”/>
<simpleType name=“complexityType”>
    <restriction base=“string”>
        <enumeration value=“HH”/>
        <enumeration value=“HM”/>
        <enumeration value=“HL”/>
        <enumeration value=“MH”/>
        <enumeration value=“MM”/>
        <enumeration value=“ML”/>
        <enumeration value=“LH”/>
        <enumeration value=“LM”/>
        <enumeration value=“LL”/>
    </restriction>
</simpleType>
```

In Table 13, the ‘complexity’ attribute is defined with the data type of string such that the value is indicated by a text having a symbolic meaning as in the definition of Table 12 except that the complexity is more precisely divided as compared to the ‘high’, ‘middle’, and ‘low’ in Table 12.

The ‘complexity’ attribute can be defined with the definitions about further information such as reference data processing unit, reference terminal platform and specification, and service environment, and this information can be reflected in the attribute value of the ‘complex’ attribute. For instance, when the reference data processing unit is clock 2000, the minimum required processing performance headroom of 9.35% can be expressed as complexity=‘3.95’ and complexity_criterion=‘2000’ or complexity=‘9.35(2000)’.

Also, the method for defining the information can vary according to the positions and of the newly introduced elements and attributes. The elements and attributes information that are newly defined according to the respective data definition formats can be composed of the initial scene composition information such as header information and the signaling information for scene update, scene update data group, scene segment, and access unit; or composed of access units or header information regardless of the actual scene information for rendering the scene related to the signaling. In case of being structured in a data format for signaling, the newly defined elements and attributes can be composed of fields for indicating corresponding information.

The complexity information that can include the media-related information such as operation amount, memory, image, font, video and audio, and the information about various elements composing the content such as text, graphics, and interaction can be used as the information describing a scene component element, the information for describing a grouped element, a data set, or a file, or the signaling information of header type.

### Third Embodiment

In the third embodiment of the present invention, the terminal detects variation of the memory capacity required to render the scene, i.e. the change of processing availability to the terminal's processing headroom and the complexity, and changes the scene dynamically according to the variation of the required memory capacity.

In the LASeR content processing, changes of the network session management, decoding process, and condition and operation of the terminal, and data and the input/output on the interface can be defined events. The LASeR engine can detect these events and changes the scene or operation of the terminal based on the detected events. Accordingly, in the third embodiment of the present invention, the change of the memory capacity required to render the scene, i.e. the change of processing headroom and processing availability to the complexity can be defined as an event.

As an example of processing the new event, when the terminal, i.e. LASeR engine, detects the new event, the terminal executes a related command through an ev:listener (listener) element. Here, the related command can relate to various operations including function execution or element and command execution.

Table 14 shows the definitions about the new events related to the change of memory status of the terminal. If the memory status of the terminal changes, this means that the processing availability to the terminal's processing headroom and complexity changes. The new events can use a specific namespace. Any type of namespace can be used if it allows grouping the new events, i.e. it can be used as the identifier (ID).

TABLE 14

| Event name | Namespace | Description |
|---|---|---|
| Memory | Urn:mpeg:mpeg4:laser:2009 | O\| This event occurs when the |
| StatusChanged | | terminal memory changes. |
| MemoryStatus(A) | Urn:mpeg:mpeg4:laser:2009 | The event occurs when the |
| | | terminal memory changes as |
| | | much as over A. |
| MemoryStatus(B) | Urn:mpeg:mpeg4:laser:2009 | This event occurs when the |
| | | terminal changes to B. |
| MemoryStatus(A, B) | Urn:mpeg:mpeg4:laser:2009 | This event occurs when the |
| | | information (parameter) B on |
| | | the terminal memory changes |
| | | as much as over A. |
| MemoryStatus | Urn:mpeg:mpeg4:laser:2009 | This event occurs when the |
| (a, b, c, d, e) | | memory changes as much as |
| | | over the memory sizes |
| | | expressed by a, b, c, d, and e. |

In Table 14, the ‘MemoryStatusChanged’ event occurs when it is determined that the terminal's processing availability to the processing headroom and the complexity is changed due to the change of the memory of the terminal. The ‘MemoryStatus(A)’ event occurs when it is determined that the terminal's processing availability to the processing headroom and the complexity is changed due to the change of the memory of the terminal as much as the parameter ‘A’. The parameter ‘A’ is a value indicating the occurrence of an event caused by the change of the element or the performance reflecting the terminal's processing availability to the processing headroom and the complexity is changed.

The ‘MemoryStatus(B) event occurs when it is determined that the terminal's processing availability to the processing headroom and the complexity is changed due to change of the memory to the parameter ‘B’. The parameter ‘B’ is a value indicating the change of the terminal condition to a value of ‘B’ when the terminal's processing availability to the processing headroom and the complexity is predefined with sections or intervals. The parameter ‘B’ can be expressed as a combination of various information elements. In the case where the parameter ‘B’ is configured to (A, B) or (a, b, c, d, e), the ‘MemoryStatus(B) event can be defined as MemoryStatus(A, B) or MemoryStatus(a, b, c, d, e).

The ‘MemoryStatus(A, B)’ event occurs when it is determined that the terminal's processing availability to the processing headroom and the complexity is changed due to the parameter ‘B’ indicating the information related to the memory is changed as much as ‘A’. This means that the memory related information ‘B’ is changed to a section value indicated by the parameter ‘A’ and thus the terminal's processing availability to the processing headroom and the complexity is changed.

The terminal's memory related information ‘B’ can be any of elements and information that can express the terminal's processing availability to the processing headroom and the complexity that is defined in the present invention. Accordingly, the information ‘B’ can be the operation amount, the information related to the media such as image, font, video, and audio, the information related to the number of text Unicodes, number of graphic points, and interaction, and complexity information including the above information. In such information, i.e. ‘MemoryStatus(A, B) event, the information ‘B’ can be expressed with a mimeType, a predefined expression, or referencing internal/external data set as the data that can be referenced outside.

In case that a predefined expression “‘a’ is number of text Unicodes, ‘b’ is number of graphic points, ‘c’ is memory requirement for rendering video, ‘d’ is memory requirement for drawing image, and ‘e’ is sum of maximum sampling rate required for sampling audio” is given and ‘memoryStatus(300, b) event occurs, the terminal recognizes that a memory size equal to the amount required for drawing 300 graphic points is changed.

The ‘MemoryStatus(a, b, c, d, e)’ event occurs when it is determined that the terminal's processing availability to the processing headroom and the complexity is changed due to the information related to the terminal's memory is changed as indicated by the parameters a, b, c, d, and e. In this case, the terminal must know the meanings of positions in the parameter sequence of a, b, c, d, and e in sequential order. For instance, when the parameter sequence ‘a, b, c, d, e’ is predefined as [number of text Unicodes, number of graphic points, memory amount required for rendering video, memory amount required for drawing image, sum of maximum sampling rate for sampling audio] and the ‘MemoryStatus(2, 30, 200, 100, 200) event occurs, the terminal recognizes that a memory size equal to the amount required for processing two text Unicodes, 30 graphic points, 200 kb video, 100 kb image, and 200 kb audio is changed.

All the parameters including ‘A’, ‘B’, and so forth can be expressed in various types including absolute value, relative value, and other types of values having specific meanings. The value having specific meaning can be presented in symbolic expression and indicating a group or a set and predefined internally/externally so as to be referenced. The event expresses pairs of parameter type (A, B, C, . . . ) and real values (a, b, c) as in “MemoryStatus(a, B, b, c, C, . . . ) without limitation in number. If it is required to express one parameter pair with multiple instances, the event can be defined to express with pairs as much as required number.

Tables 15 to 17 show the definitions on the interface for the events occurring in accordance with the change of the terminal's processing availability to the processing headroom and the complexity using an interface definition language. The Interface Definition Language (IDL) is a specification language used to describe the definition and functions of the interface. The IDL describes an interface in a language-neutral way enabling communication between software components that do not share language. The ‘MemoryStatus’ interface of Tables 15 to 17 can provide the contextual information on the event occurring when the terminal's processing availability to the processing headroom and the complexity is change, and the event type of the ‘MemoryStatus’ interface can be an event in accordance with the change of the terminal's processing availability to the processing headroom and the complexity that has been described with reference to Table 9 and embodiments of the present invention. The attributes of the ‘MemoryStatus’ interface can be any enabling expressing of the properties related to the terminal performance, i.e. resources. Although the attributes are expressed with parameter types of float, Boolean, and long in the following description, it is not limited thereto but can be changed to any of all data types available in LASeR if there are specific attributes of the interface to be expressed differently.

TABLE 15

```
[IDL(Interact Definition Language) Event Definition]
interface LASeREvent : events::Event( ); // General IDL Definition
of LASeR events
  interface MemoryStatus : LASeR Event {
  readonly attribute float absoluteValue;
  readonly attribute Boolean computableAsFraction;
  readonly attribute float fraction;
  readonly attribute long memoryParameter;
}
No defined constants
Attributes
absoluteValue : This value indicate current status of the resource.
computableAsFraction : This value indicates whether a fraction of the
resource can be calculated with absoluteValue.
fraction : This value is in the range between 0 and 1 and indicates the
current status of the resource in rate.
memoryParameter : This indicate variation (displacement) of a value
representing the change of the memory.
```

In Table 15, ‘memoryParameter’ is a value indicating the variation (i.e. displacement) of the value representing the change of the memory of the terminal. This can be expressed as the difference between the previously occurring event and the currently occurring event. This parameter can be expressed with more than one variable. In case that the parameter related to the memory of the terminal is [number of text Unicodes, number of graphic points, memory amount required to render video, memory amount required to draw image, sum of maximum sampling rates required for sampling audio, . . . ], this can be expressed using respective variables as following:

interface MemoryStatus : LASeR Event {
readonly attribute float absoluteValue;
readonly attribute Boolean computableAsFraction;
readonly attribute float fraction;
readonly attribute long GraphicsPoints;
readonly attribute long TextUniCode;
readonly attribute long Image;
readonly attribute long Video;
readonly attribute long Audeo;
...
}

The above described interface can be expressed in a different manner as follows:

```
interface MemoryStatus : LASeR Event {
      readonly attribute float absoluteValue;
      readonly attribute Boolean computableAsFraction;
      readonly attribute float fraction;
      for(i=0; i<n; i++){
            readonly attribute long memoryParameter[i];
      }
    }
```

The attributes of the interface can be expressed in specific expressions as shown in Table 16, and the values can further include attributes of detail, ParameterType, and the like of DomString type.

```
TABLE 16
[IDL(Interact Definition Language) Event Definition]
interface LASeREvent : events::Event( ); // General IDL Definition
of LASeR events
interface MemoryStatus : LASeR Event {
    readonly attribute float absoluteValue;
    readonly attribute Boolean computableAsFraction;
    readonly attribute float fraction;
    for(i=0; i<n; i++){
        readonly attribute long memoryParameter[i];
        readonly attribute DOMString ParamenterType[i];
    }
    //readonly attribute DOMString detail;
}
or
interface MemoryStatus : LASeR Event {
    readonly attribute float absoluteValue;
    readonly attribute Boolean computableAsFraction;
    readonly attribute float fraction;
    for(i=0; i<n; i++){
        readonly attribute long memoryParameter[i];
    }
    readonly attribute DOMString ParamenterType;
    //readonly attribute DOMString detail;
}
No defined constants
Attributes
absoluteValue : The value indicates current status of resource.
computableAsFraction : The value indicates whether the fraction of the
resource can be calculated using aboluteValue.
fraction : This value is in the range between 0 and 1 and indicates the
current status of the resource in rate.
memoryParameter : This indicate variation (i.e. displacement) of a value
representing the change of the memory.
memoryParameterType : This indicates a value the can express the
parameter related to the memory of the terminal.
```

In Table 17, the memoryParameter indicating the change of the memory of the terminal is configured with 5 information elements as [number of text Unicodes, number of graphic points, memory amount required to render video, memory amount required to draw image, sum of maximum sampling rates required for sampling audio], the parameter includes the combination of the 5 information elements [number of text Unicodes, number of graphic points, memory amount required to render video, memory amount required to draw image, sum of maximum sampling rates required for sampling audio]. As another example, each parameter can be expressed as a pair of parameter value and parameter type [parameter value, parameter type].

```
TABLE 17
[IDL(Interact Definition Language) Event Definition]
interface LASeREvent : events::Event( ); // General IDL Definition
of LASeR events
interface MemoryStatus : LASeR Event {
    readonly attribute float absoluteValue;
    readonly attribute Boolean computableAsFraction;
    readonly attribute float fraction;
    readonly attribute DOMString memoryParameter;
}
or
interface MemoryStatus : LASeR Event {
    readonly attribute float absoluteValue;
    readonly attribute Boolean computableAsFraction;
    readonly attribute float fraction;
    for(i=0; i<n; i++){
        readonly attribute DOMString memoryParameter[i];
    }
}
No defined constants
Attributes
absoluteValue : This value indicate current status of the resource.
computableAsFraction : This value indicates whether a fraction of the
resource can be calculated with absoluteValue.
fraction : This value is in the range between 0 and 1 and indicates the
current status of the resource in rate.
memoryParameter: combination of parameters indicating change of the
memory of the terminal.
```

The type of the above described interface can be defined in various ways. Although not described with syntax in the embodiments of the present invention, other methods, if including the attribute and information related to the value indicating the change of the value expressing the variation of the memory of the terminal, are envisioned by the present invention.

Table 18 shows an exemplary scene composition using the above defined events. In case that a, b, c, d, and e are combined in series with the definition of [number of text Unicodes, number of graphic points, memory amount required to render video, memory amount required to draw image, sum of maximum sampling rates required for sampling audio], and ‘MemoryStatus(2, 30, 200, 100, 200)’ event occurs, the event listener recognizes that the memory size equal to the amount required for processing two text Unicodes, 30 graphic points, 200 kb video, 100 kb image, and 200 kb audio is changed, and commands the event handler to execute the operation of ‘MemoryChanged’. The ‘MemoryChanged’ executes <Isr:RefreshScene/> to newly draw the scene.

TABLE 18

<ev:listener handler=‘#MemoryChanged’ event=‘MemoryStatus(2,
30, 200, 100. 200)’ />
<script id=‘MemoryChanged’>
<Isr:RefreshScene/>
</script>

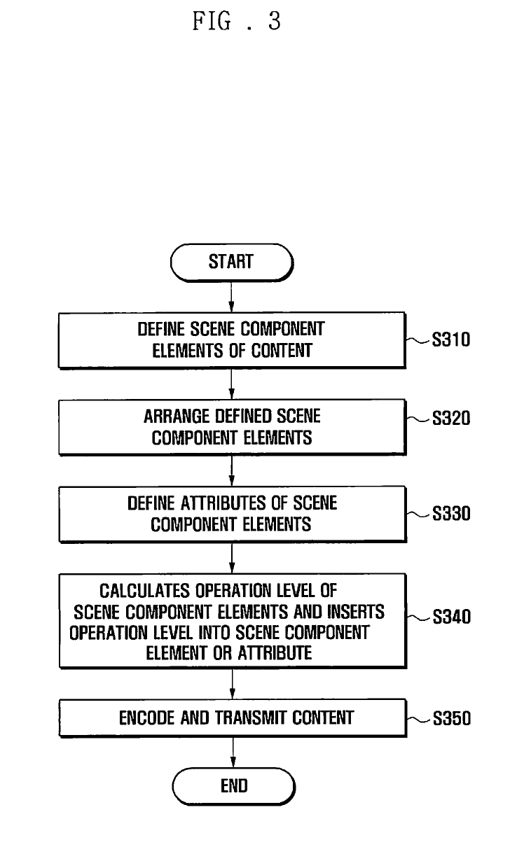

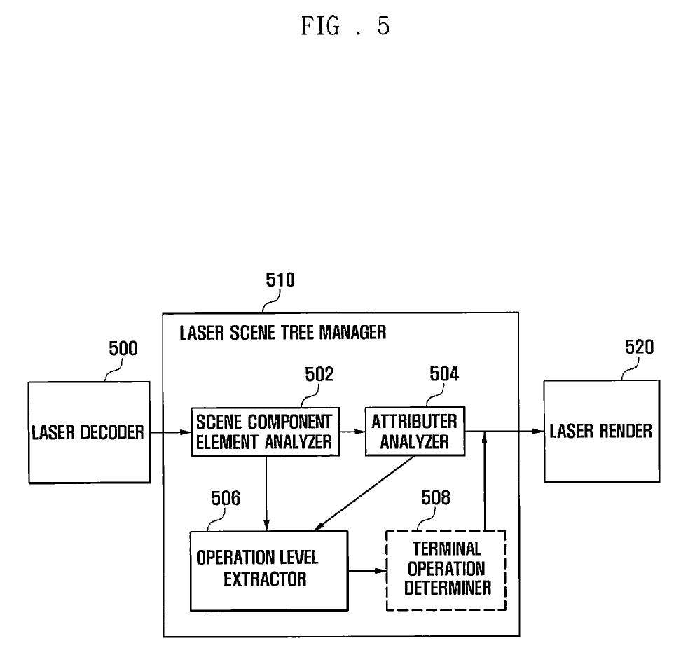

Operations of the transmitter which generates a rich media content according to the first to third embodiments and a receiver which renders the rich media content transmitted by the transmitter are described with reference to FIGS. 2 and 5. Although the operations of the transmitter and receiver are described under the assumption that the rich media content is a LASeR content in FIGS. 2 and 3, the present invention can be applied to other types of media contents. In the following descriptions, the terms ‘rich media content’ and ‘LASeR content’ are used synonymously.

FIG. 3 is a flowchart illustrating a method for a transmitter to generate and transmit a LASeR content according to the first to third embodiments of the present invention.

Referring to FIG. 3, the transmitter defines a scene component element of the corresponding LASeR content in step 310. Next, the transmitter aligns the defined scene component element to be placed at a predetermined position in step 320.

Next, the transmitter defines attributes of the scene component element in step 330. After defining the attributes, the transmitter calculates the operation level of the scene component element and adds the calculated operation level to the scene component element or the attribute so as to generate the content in step 340. At this time, the transmitter can add the information related to the memory to the scene component element or the attribute as well as the operation amount, as described above. In an exemplary embodiment of the present invention, the transmitter also can add a complexity including the operation information to the scene component element or the attribute.

Although it is depicted that the operation level is added after the scene component element and the attribute of the scene component element are defined in FIG. 3, the present invention is not limited thereto. For instance, the operation level is calculated first and then, if the scene component element and its attribute are defined following the calculation of the operation level, adds the operation level to the scene component element or the attribute.

Finally, the transmitter encodes the generated content and transmits the content to a receiver in step 350.

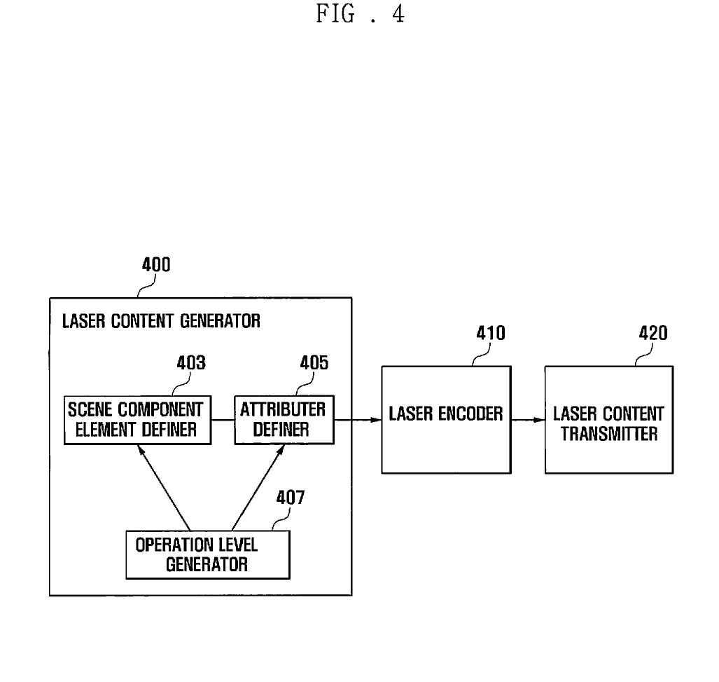

FIG. 4 is a block diagram illustrating a configuration of a transmitter for generating and transmitting a LASeR content according to an embodiment of the present invention.

Referring to FIG. 4, the transmitter includes a LASeR content generator 400, a LASeR encoder 410, and a LASeR content transmitter 420.

The LASeR content generator 400 generates a rich media content as described in the first and second embodiments of the present invention. Here, the rich media content can be a LASeR content. That is, the LASeR content generator 400 creates at least one of elements and attributes containing information such as complexity of the rich media content and operation level and memory space required for a recipient terminal to render the rich media content.

Here, the element and attribute information related to the operation level required for the recipient terminal to render the rich media content can be the elements and attributes including the information related to the operation level required for configuring the scene component element composing the rich media content. The element means a basic unit object composing a scene, and the attribute means a property of the element. For instance, a ‘g’ element as one of scene component elements composing a LASeR content has attributes related to operations such as ‘multiply’, ‘div’, ‘sub’, and ‘add’. When generating a LASeR content, the LASeR content generator 400 creates information related to the operation level required for the recipient terminal to render the LASeR data and packages the operation level information and LASeR data into a rich media content.

The LASeR content generator 400 also creates the information related to the memory space required for the recipient terminal to render the LASeR scene and packages the memory space information into the rich media content together with LASeR data. The memory-related information can include attributes listed in Table 7. In Table 7, the ‘GraphicPoints’ attribute indicates the memory amount required for the recipient terminal to render a graphics element, ‘FontDataSize’ attribute indicates the memory amount required for the recipient terminal to render the corresponding font, the ‘TextDataSize’ attribute indicates the memory amount required for the recipient terminal to render a text data, the ‘ImageProcessingMemory’ attribute indicates the memory amount required for the recipient terminal to render a image data, and the ‘VideoProcessingMemory’ attribute indicates the memory amount required for the recipient terminal to render a video data.

The LASeR content generator 400 also creates information related to the complexity required for the recipient terminal to render the LASeR scene and packages the complexity information into the rich media content together with the LASeR data. In order to calculate the complexity, various elements related to the information about the operation amount and memory amount required for the recipient terminal to render the content and others. The elements for use in calculation of the complexity can further include the elements related to the media such as image, font, video, and audio; the elements related to the text, graphics, and interaction; and the elements related to the various elements composing the content. The elements related to the media such as image, font, video, and audio and the elements related to the text, graphics, and interaction can include the information related to the data itself such as size and playback time of the data, data amount to be processed per second such as frame rate, color table, and update rate; and the information such as resolution required for the recipient terminal to process the data, display size, utilization frequency within the service scene, resource occupancy rate for the recipient terminal to process the data, memory size, power consumption amount, resource related to the data transmission, input/output-related terminal capability and configuration.

Also, the LASeR content generator 400 generates information related to the memory amount required for the terminal to render the LASeR scene, and creates the rich media content with the LASeR data and the information related to the memory amount. The terminal recognizes the variation of the memory amount required to render the LASeR scene, i.e. the processing availability to the terminal's processing headroom and the complexity and changes the scene dynamically according to the variation of the required memory amount. In the LASeR content processing, changes of the network session management, decoding process, and condition and operation of the terminal, and data and the input/output on the interface can be defined events. The LASeR engine can detect these events and changes the scene or operation of the terminal based on the detected events. Accordingly, in the third embodiment of the present invention, the change of the memory capacity required to render the scene, i.e. the change of processing headroom and processing availability to the complexity, can be defined as an event. As an example of processing the new event, when the terminal detects the new event, the terminal executes a related command through an ev:listener(listener) element. Here, the related command can be related to various operations including function execution or element and command execution.

In order to perform the above described functions, the LASeR generator 400 includes a scene component element definer 403, an attribute definer 405, and an operation level calculator 407. Although not depicted in FIG. 4, the transmitter can further include other function blocks. However, the function blocks that are not directly related to the present invention are omitted.

The scene component element definer 403 defines scene component elements composing a scene of the content and arranges the scene component elements to be placed predetermined positions.

The attribute definer 405 defines attributes of the scene component elements.

The operation level calculator 407 calculates the operation level, complexity, and values of memory-related elements and attributes that are described above. The operation level calculator 407 adds the calculated values to the defined scene component elements and attributes selectively.

The LASeR content generator 400 outputs the LASeR content to the LASeR encoder 410. The LASeR encoder 410 encodes the LASeR content (including at least one of LASeR data, information related to the operation level and memory amount, and complexity information) output by the LASeR content generator 400 and outputs the encoded LASeR content to the LASeR content transmitter 420. The LASeR content transmitter 420 transmits the Encoded LASeR content output by the LASeR encoder 410 to the recipient terminal.

As described above, the transmitter generates the new elements and attributes containing information relating to the operation amount required for the recipient terminal to render the scene component elements composing the LASeR content and transmits the new elements and attributes information together with the LASeR content.

FIG. 5 is a block diagram illustrating a configuration of a receiver for receiving and processing a LASeR content transmitted by a transmitter according to an embodiment of the present invention.

Referring to FIG. 5, the receiver includes a LASeR decoder 500 a LASeR scene tree manager 510, and a LASeR render 520.

Once a LASeR content is received, the LASeR decoder 500 decodes the LASeR content and outputs the decoded LASeR content t the LASeR scene tree manager 510. The LASeR scene tree manager 510 analyzes information on the complexity to render the rich media content, the operation level required to process the rich media content, and/or memory amount required to render the rich media content that are described in the first and second embodiments of the present invention and checks the information related to the events and behavior related to the events. That is, the LASeR scene tree manager 510 analyzes the LASeR data output by the LASeR decoder 500 and controls configuration of the scene based on the analysis result.

For this purpose, the LASeR Scene Tree Manager 510 includes a scene component element analyzer 520, an attribute analyzer 504, an operation level extractor 506, and a terminal operation determiner 508.

The scene component element analyzer 502 receives the decoded LASeR content output by the LASeR decoder 500 and analyzers the scene component elements included in the LASeR content. Next, the scene component element analyzer 502 outputs the analyzed scene component elements to the operation level extractor 506.

The attribute analyzer 504 receives the decoded LASeR content output by the scene component element analyzer 502 and analyzes the attributes of the scene component elements of the LASeR content. Next, the attribute analyzer outputs the analyzed attributes to the operation level extractor 506.

The operation level extractor 506 extracts the complexity to render the rich media content, the operation level required to render the content, and/or the memory space required while rendering the content.

In an embodiment of the present invention, the rich media content includes the information about the complexity required for the receiver to render the rich media content or the information about the complexity of the content and/or the operation level and memory required for the receiver to render the rich media content, and the receiver analyzed the scene component element information including the above described information checks the receiver capacity and condition by means of the terminal operation determiner 508 and renders the scene with the scene component elements that are supported by the receiver.

The scene component element information checked by the LASeR scene tree manager 510 is output to the LASeR render 520. The LASeR render 520 renders the LASeR content based on the LASeR scene component element information output by the LASeR scene tree manager 510 and outputs the rendered LASeR content.

In the case where the scene component element information including the information such as the complexity of the content and/or the operation level required to render the content is used as the information for describing grouped elements, data set, or file, the receiver can check the information and filters the grouped element, data set, and/or file with reference to the receiver's capability and condition before the content is input to the LASeR decoder 500, before the content decoded by the LASeR decoder 500 is input to the LASeR scene tree manager 510, or before the data input to the LASeR scene tree manager 510 is analyzed.

In an embodiment of the present invention, the information used as the values of the newly defined attributes (i.e. the information related to the media such as operation amount, image, font, video, and audio, the information related to text, graphics, and interaction, and the information related to the various elements composing the content such as complexity information including corresponding information) can be configured to be referenced by the data, files, application programs, and services inside or outside of the LASeR. At this time, the attributes can be defined inside the LASeR such that only the attribute values are referenced, or defined with other data, file, application program, and service so as to be referenced using the elements and attributes having reference functions. Even when the attributes and attribute values are referenced using the elements and attributes having the reference functions, other methods, if having the same meaning, are envisioned by the present invention. For instance, if a ‘href’ attribute is used to reference a specific element, the operation level is defined as ‘operation(add(5), mul(10)) in another file, and ‘href=“operation(add(5), mul(10)”’ is used; this is identical with <operation add=‘5’ mul=‘10’>.

Also, a new element or a new attribute such as ‘contentsDescriptionType’ is defined for the media-related information such as operation level, complexity, image, font, video, and audio, and the information related to various elements composing the content such as text, graphics, and defining list of the attribute value, the information can be brought and used or reference other data, file, application program, or service to use. This is applied to all the embodiments of the present invention.

As described above, the method and apparatus for providing a rich media service according to the present invention allows the service provider to transmit rich media content including information such as processing complexity of the rich media content, operation amount and memory space required for a recipient terminal to render the content, whereby the recipient terminal can control receiving and rendering the content based on its capability and condition with reference to the information, and the service provider can provide the rich media service consistently without consideration of the capacities of recipient terminals.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for providing a rich media service, comprising the steps of:
defining scene component elements composing a rich media content and attributes of the scene component elements;
calculating an operation level required to render the rich media content;
generating the rich media content composed of the scene component elements and attributes, the operation level being contained one of the scene component elements and attributes; and
encoding and transmitting the rich media content.

2. The method of claim 1, wherein the operation level includes at least one of a multiplication attribute, a division attribute, an addition attribute, and a subtraction attribute.

3. The method of claim 2, wherein the step of calculating the operation level comprises generating a complexity of the rich media content, the complexity being a rate of the operation level required to render the rich media content to a maximum data processing capability.

4. The method of claim 1, wherein the step of calculating the operation level comprises generating a memory amount required to render the rich media content, the memory amount including at least one of graphics point attribute, font data size attribute, text data size attribute, image processing memory attribute, and video processing memory attribute.

5. A method for processing a rich media content composed of scene component elements and attributes of the scene component elements, comprising the steps of:
receiving and decoding the rich media content having an operation level required to render the rich media content;
extracting the operation level by analyzing the scene component elements and attributes of the rich media content; and
rendering the rich media content using the extracted operation level.

6. The method of claim 5, wherein the operation level includes at least one of a multiplication attribute, a division attribute, an addition attribute, and a subtraction attribute.

7. The method of claim 5, wherein the operation level includes a complexity of the rich media content, the complexity being a rate of the operation amount required to render the rich media content to a maximum data processing capability.

8. The method of claim 5, wherein the operation level includes a memory amount required to render the rich media content, the memory amount including at least one of graphics point attribute, font data size attribute, text data size attribute, image processing memory attribute, and video processing memory attribute.

9. A transmitter for providing a rich media service, comprising:
a scene component element definer which defines scene component elements composing a rich media content and arranges the scene component element to be placed at predetermined positions;
an attribute definer which defines attributes of the scene component elements;
an operation level calculator which calculates an operation level required to render the rich media content and inserts the operation amount at least one of the scene component elements and attributes;
an encoder which encodes the rich media content composed of the scene component elements and attributes; and
a content transmitter which transmits the encoded rich media content.

10. The transmitter of claim 9, wherein the operation level includes at least one of a multiplication attribute, a division attribute, an addition attribute, and a subtraction attribute.

11. The transmitter of claim 9, wherein the operation level includes a complexity of the rich media content, the complexity being a rate of the operation amount required to render the rich media content to a maximum data processing capability.

12. The transmitter of claim 9, wherein the operation level includes a memory amount required to render the rich media content, the memory amount comprising at least one of graphics point attribute, font data size attribute, text data size attribute, image processing memory attribute, and video processing memory attribute.

13. A receiver for rendering a rich media content composed of scene component elements and attributes of the scene component elements, comprising:
a decoder which decodes a rich media content having an operation level required to render the rich media content;
a scene tree manager which analyzes scene information of the rich media content and composes the rich media content according to the analysis result; and
a renderer which renders and outputs the composed rich media content.

14. The receiver of claim 13, wherein the scene tree manager comprises:
a scene component element analyzer which analyzes the scene component elements of the received rich media content;
an attribute analyzer which analyzes the attributes of the scene component elements; and
an operation amount extractor which extracts the operation level required to render the rich media content from the analyzed scene component elements and attributes.

15. The receiver of claim 13, wherein the operation level includes at least one of a multiplication attribute, a division attribute, an addition attribute, and a subtraction attribute.

16. The receiver of claim 13, wherein the operation level includes a complexity of the rich media content, the complexity being a rate of the operation amount required to render the rich media content to a maximum data processing capability.

17. The receiver of claim 13, wherein the operation level includes a memory amount required to render the rich media content, the memory amount comprising at least one of graphics point attribute, font data size attribute, text data size attribute, image processing memory attribute, and video processing memory attribute.
